(19) United States
(12) Patent Application Publication
(10) Pub. No.: US 2006/0085218 A1
(43) Pub. Date: Apr. 20, 2006

(54) Vehicle downtime reporting tool

(75) Inventor: Tom D. DeBoard, Portland, OR (US)

Correspondence Address: KLARQUIST SPARKMAN, LLP, 121 SW SALMON STREET, SUITE 1600, PORTLAND, OR, 97204, US

(73) Assignee: Freightliner LLC

(21) Appl. No.: 11/254,329

(22) Filed: Oct. 19, 2005

Related U.S. Application Data
(60) Provisional application No. 60/620,563, filed on Oct. 19, 2004.

(51) Int. Cl. G06Q 99/00

(52) U.S. Cl. 705/1

(57) ABSTRACT

A vehicle downtime reporting tool comprises a computer-implemented interface to a database, wherein the database contains time-related information pertaining to a repair order for a vehicle, a computer-implemented downtime calculator that calculates the vehicle downtime by determining the time from a triggering event to an ending event, and a computer-implemented report provider that provides a report of the calculated downtime for the vehicle.

### CROSS-REFERENCE TO RELATED APPLICATION

This application claims the benefit of U.S. Provisional Application No. 60/620,563, filed Oct. 19, 2004, which is hereby incorporated by reference.

### TECHNICAL FIELD

This application relates to software applications used to track and perform calculations on time-related information for vehicles that are in a vehicle repair facility for maintenance or repair.

### BRIEF DESCRIPTION OF THE DRAWINGS

FIG. 1 is a block diagram illustrating an exemplary vehicle downtime reporting tool.

FIG. 2 is an illustration of an exemplary graphical user interface (GUI) that can provide report information.

### DETAILED DESCRIPTION

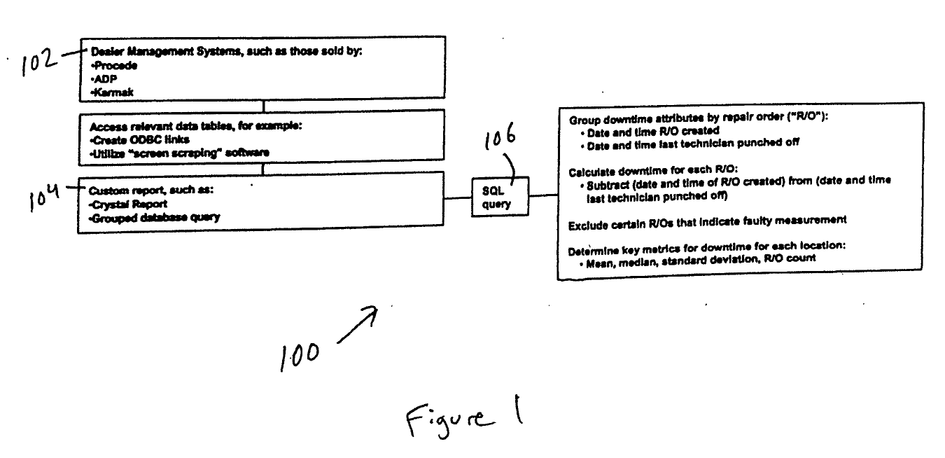

FIG. 1 illustrates an exemplary vehicle downtime reporting tool 100 that can be used to determine how much downtime has elapsed. Downtime may be defined as the elapsed time from the writing or entry of a repair order (“R/O”) to the time the job is completed by the last person to work on the last job to be completed on the vehicle.

In one example, a dealer management system (e.g., the exemplary dealer management system 102 of FIG. 1) such as Procede can be used in connection with or as part of the downtime report tool.

In one example, the downtime report tool involves creating ODBC links (e.g., to establish database connectivity to a database such as one that stores information relating to a technician's time at work or on a specific project). Screen scraping software can be used (e.g., to extract data from a file sent to be printed) to retrieve data to be used in computations.

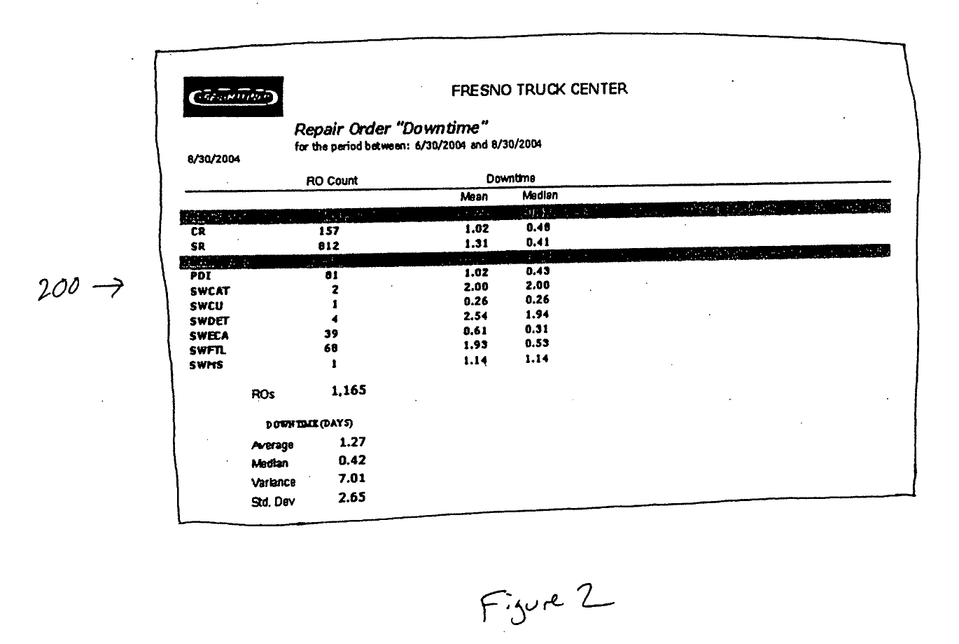

In one example, a custom report (e.g., the exemplary custom report 104 of FIG. 1) can be used, such as Crystal Report. A SQL query (e.g., the exemplary SQL query 106 of FIG. 1) can be used to group certain attributes (e.g., by repair order), such as in a report 200 shown in FIG. 2. For example, such attributes can include the date/time a repair order (“R/O”) was created and the date/time the last technician to work on the R/O punched off of that particular R/O. An R/O may include multiple jobs or services to be performed on a vehicle. A downtime can be calculated for a particular R/O by subtracting the date/time the R/O was created from the date/time the last technician punched off (e.g., completed) the last job to be done on the R/O. Selectively, certain jobs may be eliminated from downtime computations. For example, if no R/O is written, a job takes less than a threshold time to complete (e.g., 30 minutes), or the job takes longer than a threshold time to finish (e.g., one month). The thresholds may be varied. Additionally, key metrics for downtime at each location can be determined. Such key metrics can include mean, median, standard deviation, and R/O count. These metrics can be displayed, for example, by an interface such as the exemplary graphical user interface (GUI) 200 illustrated in FIG. 2.

The downtime computations may be used, for example, in evaluating the efficiency of a vehicle repair facility. The efficiency may be evaluated relating to specific jobs also. The in-shop downtime may also be started and finished with another triggering and ending event (such as the time the first job of an R/O is started, or the time the vehicle operator retrieves the vehicle), but the above approach is desirable.

Having illustrated and described the principles of the invention by several embodiments, it should be apparent that those embodiments are illustrative only and should not be construed as limiting the scope of the present invention. The present invention encompasses all such embodiments as may come within the scope and spirit of the following claims and equivalents thereto.

We claim:

1. A vehicle downtime reporting tool, comprising:
a computer-implemented interface to a database, wherein the database contains time-related information pertaining to a repair order for a vehicle;
a computer-implemented downtime calculator that calculates the vehicle downtime by determining the time from a triggering event to an ending event; and
a computer-implemented report provider that provides a report of the calculated downtime for the vehicle.

2. The vehicle downtime reporting tool of claim 1, further comprising a graphical user interface (GUI) that displays the calculated downtime for the vehicle.

3. The vehicle downtime reporting tool of claim 1, further comprising a data extraction tool that extracts the at least some of the time-related information in the database from the database.

4. The vehicle downtime reporting tool of claim 3, further comprising a SQL query that groups a plurality of attributes from the extracted information.

5. The vehicle downtime reporting tool of claim 1, wherein the interface to the database includes ODBC links.

6. The vehicle downtime reporting tool of claim 1, further comprising screen scraping software that extracts data from a file sent to be printed, wherein the calculated downtime for the vehicle is also based on the extracted data.

7. The vehicle downtime reporting tool of claim 1, further comprising an interface to a dealer management system.

8. The vehicle downtime reporting tool of claim 1, wherein the computer-implemented report provider is Crystal Reports.

9. The vehicle downtime reporting tool of claim 1, wherein the triggering event corresponds to creation of the repair order.

10. The vehicle downtime reporting tool of claim 1, wherein the ending event corresponds to completion of work for the repair order.

11. A computer-implemented method of monitoring vehicle downtime, comprising:
connecting to a database;
extracting from the database data corresponding to a repair order for a vehicle in a vehicle repair facility;
extracting from the database data corresponding to time clock entries made by at least one vehicle technician doing work corresponding to the repair order for the vehicle; and
performing a downtime calculation based on at least some of the data extracted from the database.

12. The computer-implemented method of claim 11, further comprising displaying the downtime calculation in a graphical user interface (GUI).

13. The computer-implemented method of claim 12, further comprising:
continually performing the downtime calculation after a time interval according to a refresh rate; and
refreshing the displayed downtime calculation according to the refresh rate.

14. The computer-implemented method of claim 11, wherein the act of connecting to a database comprises creating ODBC links to the database.

15. The computer-implemented method of claim 11, wherein the act of performing the downtime calculation comprises determining when the repair order was created.

16. The computer-implemented method of claim 15, wherein the act of performing the downtime calculation further comprises determining when a final time clock entry was made by the vehicle technician.

17. The computer-implemented method of claim 16, wherein the act of performing the downtime calculation further comprises determining the time difference between when the repair order was created and when the final time clock entry was made by the vehicle technician.

18. The computer-implemented method of claim 17, wherein the act of performing the downtime calculation further comprises subtracting at least one unit of time from the determined time difference.

19. The computer-implemented method of claim 17, further comprising evaluating efficiency of the vehicle repair facility based on at least one downtime calculation.

20. A vehicle downtime reporting tool system, comprising:
a computer-implemented interface to a database containing a plurality of data fields, the plurality of data fields comprising a first timestamp and a second timestamp, wherein the first timestamp corresponds to when a repair order for a vehicle was created and the second timestamp corresponds to when a final job associated with the repair order has been completed;
a computer-implemented downtime calculating tool that calculates a downtime for the vehicle by subtracting the first timestamp from the second timestamp; and
a computer-implemented interface that displays the calculated downtime for the vehicle.
